(19) United States
(12) Patent Application Publication
(10) Pub. No.: US 2026/0203430 A1
(43) Pub. Date: Jul. 16, 2026

(54) ACCESS CONTROL SOLUTION

(71) Applicant: KONE Corporation, Helsinki (FI)

(72) Inventor: Jouni Junes, Helsinki (FI)

(73) Assignee: KONE Corporation, Helsinki (FI)

(21) Appl. No.: 19/559,484

(22) Filed: Mar. 6, 2026

Related U.S. Application Data
(63) Continuation of application No. PCT/EP2023/077752, filed on Oct. 6, 2023.

(51) Int. Cl. G06F 21/62; G06F 21/32

(52) U.S. Cl. CPC G06F 21/62; G06F 21/32; G06F 2221/2141

(57) ABSTRACT

A method for generating information with respect to an access right is provided, the method includes: receiving an access request message, the access request message including identification data of a person; determining based on the identification data if the person is provided with the access right; generating, in response to a detection that the person is not provided with the access right, an information message including data providing at least one instruction to acquire the access right. Also an apparatus and a computer readable medium are provided.

### TECHNICAL FIELD

The invention concerns in general the technical field of access control.

### BACKGROUND

Access right management is an important approach in managing security aspects in various types of premises. For example, a use of doors, gates and even different kinds of systems, such as elevator systems, may be controlled by applying a security hierarchy between different users in order to maintain the security in the premises. This may e.g. to correspond that some users are allowed to access a first area whereas another group of users may access to another area in the premises.

Typical implementation of an access control system is that the users are provided with identification means. When the user enters to a user enters an access control location, she/he uses the identification means to communicate with a reader device, or with a similar access control device, in order to provide an identification data of the user to the access controller through the reader device. The access controller compares the identification data to data stored in a security database and if the user is provided with an access right, the access controller generates a control signal to a device, such as to a door or a gate, in the access control location in order to enable the user to access through the respective device. In the described implementation some non-limiting examples of the identification means storing the identification data may be a magnetic card, a RFID tag, a QR or bar code tag, or a mobile terminal. In some approach the identification data is not a specific device, but it is a biometric marker obtained from the user with a specific reader device, such as a face reader, a fingerprint reader, a palm reader, an eye (iris) reader, and so on.

The above-described systems are operative as such especially as long as the data defining the user access rights is up to date. However, a situation in which a user provides the identification data at the access control location, but the access is not granted, causes frustration. This is especially true in a sense that the user may in good faith believe that she/he is provided with the access but it is rejected at the location for some reason and the only information provided to the user is a light signal (e.g. red led light) and/or a sound signal. This leaves the user alone at the location and there is no way solve the access right problem because the user is unaware what to do.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An object of the invention is to present a method, an apparatus and a computer program for generating information with respect to an access right.

The objects of the invention are reached by a method, an apparatus and a computer program as defined by the respective independent claims.

According to a first aspect, a method for generating information with respect to an access right is provided, the method comprises:

receiving an access request message, the access request message comprising identification data of a person,

determining based on the identification data if the person is provided with the access right,

generating, in response to a detection that the person is not provided with the access right, an information message comprising data providing at least one instruction to acquire the access right.

For example, the identification data may be received from at least one of: a reader device, a mobile terminal of the person.

The identification data may be at least one of: access credentials, biometric data of the person.

The information message may be generated to at least one output device residing in a location the person provided the identification data. For example, the output device may be the mobile terminal of the person. Moreover, the method may further comprise:

inquiring, in response to the detection that the person is not provided with the access right, contact information of the person from data storage, and

applying the contact information in the generation of the information message.

The data in the information message may comprise at least one of: a contact information, a network link.

According to a second aspect, an apparatus for generating information with respect to an access right is provided, the apparatus is configured to:

receive an access request message, the access request message comprising identification data of a person,

determine based on the identification data if the person is provided with the access right,

generate, in response to a detection that the person is not provided with the access right, an information message comprising data providing at least one instruction to acquire the access right.

The apparatus may be arranged to receive the identification data from at least one of: a reader device, a mobile terminal of the person.

For example, the apparatus may be configured to receive the identification data in a form of at least one of: access credentials, biometric data of the person.

The apparatus may be configured to generate the information message to at least one output device residing in a location the person provided the identification data. For example, the apparatus may be configured to generate the information message to the mobile terminal of the person operating as the output device. Moreover, the apparatus may further be configured to:

inquire, in response to the detection that the person is not provided with the access right, contact information of the person from data storage, and

apply the contact information in the generation of the information message.

The apparatus may be configured to insert as the data in the information message at least one of: a contact information, a network link.

According to a third aspect, a computer program is provided, the computer program comprising instructions to cause the apparatus according to the second aspect as defined above to execute the steps of the method according to the first aspect as defined above.

The expression "a number of” refers herein to any positive integer starting from one, e.g. to one, two, or three.

The expression "a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically a system according to an example.

FIG. 2 illustrates schematically a method according to an example.

FIG. 3 illustrates schematically an apparatus according to an example.

### DESCRIPTION OF THE EXEMPLIFYING EMBODIMENTS

The specific examples provided in the description given below should not be construed as limiting the scope and/or the applicability of the appended claims. Lists and groups of examples provided in the description given below are not exhaustive unless otherwise explicitly stated.

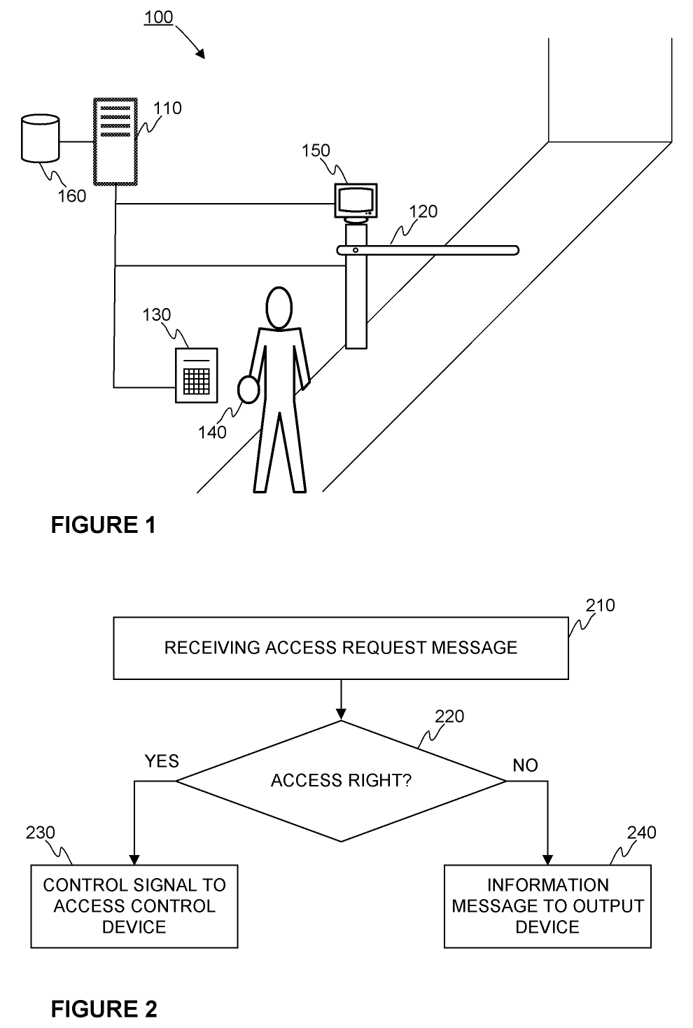

At least some aspects of the present invention are described by referring to FIG. 1 schematically illustrating at least some entities of a system configurable to implement the present invention. The system is configured to manage access rights in premises, such as in buildings or similar, wherein access to various parts of the premises is limited between persons and/or person groups. The access management system 100 may be implemented so that the persons may be provided with a device 140 that is arranged to exchange data with an entity of an access management system in some manner and an access controller 110 determines the access right and generates one or more control signals accordingly. The example of the access management system 100 as shown in FIG. 1 comprises the access controller 110 and an access control device 120 that is a boom gate. Moreover, the access management system 100 comprises a reader device 130 that is configured to interact with the device 140 provided to the person. Furthermore, the access management system comprises an output device 150 that is a display in the implementation according to FIG. 1.

There are a number of ways to implement the access management system as such and in the following it is described some approaches applicable in the context of the present invention. For the determination of the access right the access controller 110 requires receiving as an input data something by means of which it is possible to identify the person aiming to access through an access point. The data identifying the person, aka identification data, may be stored in the device 140 provided to the person and the data is read therefrom with a reader device 130 suitable for the task. For example, the device 140 may be implemented with a magnetic card, a tag (e.g. RF ID tag), a QR code tag, a bar code tag, and so on. Further, the device 140 may be a mobile terminal or similar that exchanges the data identifying the user with the reader device 130, or directly with the access controller 110 e.g. through a base station over an applied wireless communication technology. Naturally, any short range communication, such as Near Field Communication (NFC) technology may be used in the context of the mobile terminal if the mobile terminal is equipped with such a technology. Some embodiments of the invention may be based on an approach that the data identifying the person is so-called biometric data consisting of a number of biometric markers. The biometric data may be obtained with various reader devices 130 applied in the system, such as with a face reader, with a fingerprint reader, with a palm reader, with an eye (iris) reader, and so on. In this kind of approach the person is not necessarily provided with any device 140 storing the data identifying the person since the obtainment of the data identifying the person is arranged in another way.

In addition to the implementation of the reader device 130 and/or the device 140, or the obtainment of the data identifying the person in general, the access management system 100 may utilize various types of access control devices 120. As mentioned, FIG. 1 illustrates a boom gate as an example of the access control device 120 at a location, but the access control device 120 may be any other type of gate, such as a turnstile gate, a flap gate, a swing gate listed as some non-limiting examples. Furthermore, the access control device 120 may be implemented as a door. Still further, the access control device 120 may refer to a control device of a system required for accessing between different locations. An example of such system may be an elevator allowing access between floors and the access control device 120 may in the elevator context be a car operating panel, or any other user interface of the elevator, whose operation may be made dependent on access rights so that the data identifying the person is used for deciding if a person is granted an access right to use the respective user interface or not.

For sake of completeness, it is worthwhile to mention that the access controller 110 may be provided with reference data used with respect to the data identifying the person to determine if the right to access may be provided to the person in question or not. The reference data may be stored in a data storage 160 accessible to the access controller 110 e.g. in a form of a database into which it is possible to perform inquiries e.g. with the data identifying the person. Hence, the access controller 110 may validate the data identifying the user with respect to the reference data stored in the data storage 160 and in that manner determine if the person has right to access the access control device 120 or not. The reference data stored may comprise such a piece of data that indicates, or defines, the access rights of the person and the access controller 110 may interpret it accordingly. As a result the access controller 110 may be configured to generate a control signal in a manner as is described in the forthcoming description.

In accordance with the invention the output device 150 may also be implemented in various ways. As shown in FIG. 1 the output device 150 may be a display residing so that the person may see the information shown on it. In accordance with some other embodiment, the mobile terminal of the person or similar, i.e. the device 140, may be applied as the output device 150 for showing information to the person. Alternatively or in addition, the premises may be provided with one or more image projection devices to output information to at least one predefined location, such as to a floor or to a wall or even to a ceiling or to any combination of these.

Next, at least some aspects relating to the invention is described by referring to FIG. 2 illustrating a method for managing an access procedure comprising specifically a generation of information with respect to an access right. The method is primarily described from the access controller 110 point of view. In step 210, the access controller 110 receives 210 an access request message. The access request message may be received from the reader device 130 or from a mobile terminal possessed by the person. The access request message comprises identification data of the person. In order to generate the access request message with the data as described the respective entity, such as the reader device 130 or the mobile terminal, for example, may receive input from the person in one manner or another. For example, the user may arrange a device 140 to interact with the reader device 130 in a required manner to transfer data from the device 140 to the reader device 130 in order to deliver at least part of the data to the access controller 110 as the access request message. Alternatively, the reader device 130 may receive, or obtain, the data identifying the user as the biometric data as described. In addition to the including at least part of the data identifying the person in the access request message the reader device 130 may also add some further data, such as data identifying the reader device 130 in question in some manner (e.g. device identifier, location information, etc.), to the access request message so as to enable the access controller 110 to identify the reader device 130. In case of the mobile terminal the person may transfer the data identifying the person to the access controller 110 with an applied communication channel wherein the mobile terminal may associate e.g. location information to the message for being applied in identification of a location the person resides and associate that information with the access control device 120 preventing the person to access. Any other approaches may be applied to in a determination of the access control device 120 that is requested to be accessed by the person.

In response to the receipt 210 of the access request message in at least one of the manners as described the access controller 110 is configured to determine 220, based on the identification data of the person if the person is provided with the access right. In other words, the access controller 110 is configured to perform the determination by comparing at least the identification data with the reference data in order to find out if the person behind the identification data is provided with the access with respect to the access point in question. Thus, further parameters, such as the location information or the identifier of the reader device 130 may be used in the determination of the access right especially in an environment wherein there are plurality of access points, cf. access control devices 120, dividing the premises to various areas and wherein the areas are accessible with differing levels of access rights. Then there is a need to determine the access rights of persons at the area level wherein the access to the respective areas are controlled with the access control devices 120 at selected access points. In other words, the inquiry, or evaluation by the access controller 110, may correspond to a question if A person A is allowed to access through the access control device 120 at a location X? The evaluation by applying the reference data may generate an answer to the above defined question and to correspond either that the person is provided with the access right or that the person is not provided with the access right. For sake of clarity the above-defined question-and-answer combination is a put in clear words, but the technical implementation may be made by programming.

As shown in FIG. 2 if the determination in step 220 generates a result that the person is provided with the access right the access controller 110 may be configured to generate 230 a control signal to a respective access control device 120 allowing the person to access. This may e.g. correspond to that a lock is instructed to open or that a gate is instructed to open with the control signal. Here, the generation 230 of the control signal comprises a determination of the access control device 120 into which the control signal is generated to. This may be done by utilizing information on the location wherefrom the access request message is received. As described, the location may refer to the location in the premises the person resides e.g. received from the mobile terminal or from any other positioning system and/or to the location information derivable from the information on the reader device 130, as non-limiting examples. Based on the information the access controller 110 may determine the access control device 120 associated to the location, or e.g. to the reader device 130, in order to generate the control signal thereto in a correct format and manner. As a result, the person is allowed to access i.e. the access control device 120 is set to a mode that it is accessible.

On the other hand, if the access controller 110 detects based on the determination 220 that the person is not provided with the access right, it is configured to generate 240 an information message to the output device 150 wherein the information message comprising data providing at least one instruction to acquire the access right. The information message may be generated 240 so that the access controller 110 upon the detection that the person is not provided with the access right inquires data from data storage 160 that data defines at least one instruction to acquire the access right for the respective access point. The format of the instruction may e.g. be dependent on the person, i.e. the access controller 110 may utilize the identification data in the inquiry of the at least one instruction to prepare the instruction message. Such an approach is advantageous in a sense that different persons visiting the premises may be managed by different authorizing persons/parties and, therefore, the identification data identifying the person may be utilized in the preparation and provision of the instruction in a person-by-person manner. Thus, the contents for the information message(s) may be stored in a data storage 160 accessible to the access controller 110 and inquired therefrom in a predefined manner, such as with the identification data and/or with any other data, such as the location information and/or an identity of the access point and so on. The information message as such may be implemented as a control signal that causes the output device 150, or a plurality of the output devices 150, to output the desired data. Thus, the generation of the information message also comprises a determination of the at least one output device 150 to which the information is to be output. The determination of the output device 150 may comprise a utilization of a location information of the person or the reader device 130 in a corresponding manner as the access control device 120 may be determined. Alternatively or in addition, the information on the output device(s) 150 may be associated with the information on the reader device 130 and/or with the access control device 120 so as to enable the access controller 110 to determine the different entities with respect to an access point so as to control them together or individually as described herein. Thus, the access controller 110 determines the at least one output device 150 in the context of the generation of the information message and generates the information message otherwise as described so that the control message controls the output device 150 to output the information, cf. the instruction. Moreover, the instruction may be output on a display of the mobile terminal, or the device 140 in general if it is equipped with a display. In such a case, the access controller 110 may determine a contact information, such as a network address of the mobile terminal like a subscription number, on the basis of the received access request message or inquire the contact information from a data storage 160 with respect to the person and generate a signal over the applied communication channel to the mobile terminal 140 so that the instruction may be output to the person.

Regarding the content of the instruction it may also provide one or more piece of guidance to the person to find a party allowed to grant access rights. For example, the information defining the instruction may e.g. correspond to a contact information of party to solve the challenge with access right or the information may be a network link that provides the person instruction to solve the challenge with the access right. Moreover, the guidance to the person may refer to one or more information messages output in one or more output devices 150 to guide the person in the premises to reach the party allowed to grant access rights. For example, it is possible to arrange so that a number of image projection devices are arranged to consecutively project information e.g. on the floor so that the person may follow the consecutively projected image data to find the party with whom to solve the challenge with the access right. As is derivable here from the type of the instruction may vary in accordance with the way the information is output.

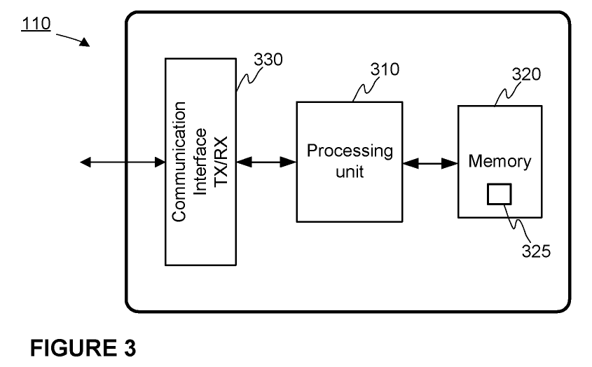

An example of an apparatus configurable to implement the operation of the access controller 110 is schematically illustrated in FIG. 3. The apparatus may be configured to perform the method according to the invention as described with the examples in the foregoing description. Thus, the apparatus of FIG. 3 may be configured to perform a generation of an information message as the control signal. For sake of clarity, it is worthwhile to mention that the block diagram of FIG. 3 depicts some components of an apparatus that may be employed to implement a functionality of the access controller 110. The apparatus of FIG. 3 comprises a processor 310 and a memory 320. The memory 320 may store data, such as pieces of data as described, but also computer program code 325 causing the operation in the described manner. In at least some embodiments, the apparatus may further comprise a communication interface 330, such as a wireless communication interface or a communication interface for wired communication, or both to communicate with other entities as described. The communication interface 330 may thus comprise one or more modems, antennas, and any other hardware and software for enabling an execution of the communication e.g. under control of the processor 310. Furthermore, I/O (input/output) components may be arranged, together with the processor 310 and a portion of the computer program code 325, to provide a user interface for receiving input from a user, such as from a technician, and/or providing output to the user of the apparatus when necessary. In particular, the I/O components may include user input means, such as one or more keys or buttons, a keyboard, a touchscreen, or a touchpad, etc. The I/O components may include output means, such as a loudspeaker, a display, or a touchscreen. The components of the apparatus may be communicatively connected to each other via data bus that enables transfer of data and control information between the components.

The memory 320 and at least a portion of the computer program code 325 stored therein may further be arranged, with the processor 310, to cause the apparatus to perform at least a portion of a method as is described herein. The processor 310 may be configured to read from and write to the memory 320. Although the processor 310 is depicted as a respective single component, it may be implemented as respective one or more separate processing components. Similarly, although the memory 320 is depicted as a respective single component, it may be implemented as respective one or more separate com-ponents, some, or all of which may be integrated / removable and / or may provide permanent / semi-permanent / dynamic / cached storage.

The computer program code 325 may comprise computer-executable instructions that implement functions that correspond to steps implemented in the method when loaded into the processor 310 of the respective entity. As an example, the computer program code 325 may include a computer program consisting of one or more sequences of one or more instructions. The processor 310 is able to load and execute the computer program by reading the one or more sequences of one or more instructions included therein from the memory 320. The one or more sequences of one or more instructions may be configured to, when executed by the processor 310, cause the apparatus, such as a computer, to perform a method as described. Hence, the apparatus may comprise at least one processor 310 and at least one memory 320 including the computer program code 325 for one or more programs, the at least one memory 320 and the computer program code 325 configured to, with the at least one processor 310, cause the apparatus implementing the computing entity to perform the method.

The computer program code 325, or at least some portion of it, may be pro-vided e.g. a computer program product comprising at least one computer-readable non-transitory medium having the computer program code 325 stored thereon, which computer program code 325, when executed by the processor 310 causes the apparatus to perform the method. The computer-readable non-transitory medium may comprise a memory device or a record medium, such as a CD-ROM, a DVD, a Blu-ray disc, or another article of manufacture that tangibly embodies the computer program. As another example, the computer program may be provided as a signal configured to reliably transfer the computer program.

Still further, the computer program code 325 may comprise a proprietary application, such as computer program code for causing an execution of the method in the manner as described in the description herein.

Any of the programmed functions mentioned may also be performed in firmware or hardware adapted to or programmed to perform the necessary tasks.

For sake of completeness it is worthwhile to mention that the entity performing the method in the role of the computing entity may also be implemented with a plurality of apparatuses, such as the one schematically illustrated in FIG. 3, as a distributed computing environment. For example, one of the apparatuses may be communicatively connected with the other apparatuses, and e.g. share the data of the method, to cause another apparatus to perform at least one other portion of the method. As a result, the method performed in the distributed computing environment generates the control interface as described. The functionalities of the computing entity as described may also be integrated to an entity configured also to perform other operations.

The invention improves an access management so that the person may be provided instructions to solve the situation if she/he is not provided with access rights. This improves a user satisfaction as well as increases an efficiency in access rights management since the person may be guided to a correct party to solve the issued.

The specific examples provided in the description given above should not be construed as limiting the applicability and/or the interpretation of the appended claims. Lists and groups of examples provided in the description given above are not exhaustive unless otherwise explicitly stated.

1. A method for generating information with respect to an access right in premises, the method, performed by an access controller comprises:
receivingan access request message, the access request message comprising identification data of a person,
determiningbased on the identification data if the person is provided with the access right, generating in response to a detection that the person is not provided with the access right, an information message to a number of output devices the information message comprising data providing at least one instruction to acquire the access right, and wherein the at least one instruction in the information message is generated to output it by projecting information consecutively with a number of image projection devices as the number of output devicesto guide the person to reach a party allowed to grant the access right.

2. The method according to claim 1, wherein the identification data is received from at least one of: a reader device a mobile terminal of the person.

3. The method according to claim 1 wherein the identification data is at least one of: access credentials, biometric data of the person.

4. The method according to claim 1,
wherein the data in the information message comprises at least one of: a contact information, a network link.

5. An apparatusfor generating information with respect to an access right in premises, the apparatusis configured to:
receivean access request message, the access request message comprising identification data of a person,
determinebased on the identification data if the person is provided with the access right, generate in response to a detection that the person is not provided with the access right, an information message to one or more output devices the information message comprising
data providing at least one instruction to acquire the access right, and wherein the at least one instruction in the information message is generated to output it by projecting information consecutively with a number of image projection devices as the output devicesto guide the person to reach a party allowed to grant the access right.

6. The apparatus according to claim 5, wherein the apparatus is arranged to receive the identification data from at least one of: a reader device a mobile terminal of the person.

7. The apparatus according to claim 6, wherein the apparatus is configured to receive the identification data in a form of at least one of: access credentials, biometric data of the person.

8. The apparatus is according to claim 5, wherein the apparatus is configured to insert as the data in the information message at least one of: a contact information, a network link.

9. A non-transitory computer-readable medium storing a computer program comprising instructions which, when the program is executed by a processor claim 5, cause the processor to execute the steps of the method of claim 1.

10. The method according to claim 2, wherein the identification data is at least one of:
access credentials, biometric data of the person.

11. The method according to claim 2, wherein the data in the information message comprises at least one of: a contact information, a network link.

12. The method according to claim 3, wherein the data in the information message comprises at least one of: a contact information, a network link.

13. The apparatus is according to claim 6, wherein the apparatus is configured to insert as the data in the information message at least one of: a contact information, a network link.

14. The apparatus is according to claim 7, wherein the apparatus is configured to insert as the data in the information message at least one of: a contact information, a network link.
